(19) United States
(12) Patent Application Publication
(10) Pub. No.: US 2025/0077132 A1
(43) Pub. Date: Mar. 6, 2025

(54) CONTROL METHOD FOR INFORMATION PROCESSING APPARATUS AND CONTROL METHOD FOR IMAGE FORMATION APPARATUS

(71) Applicant: CANON KABUSHIKI KAISHA, Tokyo (JP)

(72) Inventor: YOKO TOKUMOTO, Chiba (JP)

(21) Appl. No.: 18/818,384

(22) Filed: Aug. 28, 2024

(30) Foreign Application Priority Data
Sep. 4, 2023 (JP) 2023-142746

(51) Int. Cl. G06F 3/12

(52) U.S. Cl. CPC G06F 3/1205; G06F 3/1256

(57) ABSTRACT

A method for controlling an information processing apparatus capable of communicating with an image formation apparatus including a processor capable of controlling print processing using at least one of a non-decolorable recording material and a decolorable recording material, includes displaying a printer driver configured to transmit a print job to the image formation apparatus, and controlling switching of the printer driver between a first display in a case where the non-decolorable recording material is used and a second display in a case where the decolorable recording material is used.

### BACKGROUND

### Field

The present disclosure relates to a print setting screen of an image formation apparatus in which a type of output toner used for printing is selectable between a normal toner and a decolorable toner, and to an information processing apparatus that communicates with the image formation apparatus.

### Description of the Related Art

In recent years, along with the rise of environmental awareness such as Sustainable Development Goals (SDGS), there has been a demand for reusing paper having been printed on image formation apparatuses. With regard to this, there are known image formation apparatuses that support not only printing with normal toner, but also printing with decolorable toner that allows printing paper to be reused. In a printer driver of such an image formation apparatus that supports decolorable toner printing, there is a program that displays, on a terminal, print setting items that allow selection of toner in a toner mode that is provided in addition to a color mode. For example, see Japanese Patent Application Laid-Open No. 2018-176531.

### SUMMARY

An aspect of the present disclosure provides a method for controlling an information processing apparatus capable of communicating with an image formation apparatus including a processor capable of controlling print processing using at least one of a non-decolorable recording material and a decolorable recording material, the method including displaying a printer driver configured to transmit a print job to the image formation apparatus, and controlling switching of the printer driver between a first display in a case where the non-decolorable recording material is used and a second display in a case where the decolorable recording material is used.

Another aspect of the present disclosure provides a method for controlling an image formation apparatus including a processor capable of controlling print processing using at least one of a non-decolorable recording material and a decolorable recording material, with the method including printing an image on paper; and receiving an instruction from a user to execute the print processing, the instruction being input on a display screen that is configured to display at least one print processing setting to the user, with the display screen being switchable between a first display in a case where the non-decolorable recording material is used and a second display in a case where the decolorable recording material is used.

Further features of the present disclosure will become apparent from the following description of exemplary embodiments with reference to the attached drawings.

### BRIEF DESCRIPTION OF THE DRAWINGS

FIG. 1 illustrates components of a printing system.

FIG. 2 is a system configuration diagram of a personal computer (PC).

FIG. 3 is a system configuration diagram of an image formation apparatus.

FIG. 4 is a software configuration diagram of the image formation apparatus.

FIG. 5 is a flowchart illustrating processing of accepting print settings by the PC.

FIG. 6 illustrates a printer driver selection screen of an application.

FIGS. 7A and 7B illustrate print setting screens of a printer driver.

FIG. 8 illustrates a print setting screen of the printer driver at the time of selecting paper.

FIG. 9 illustrates a print setting screen of the printer driver at the time of setting stapling or the like.

FIG. 10 illustrates a print setting screen of the printer driver at the time of selecting a color mode.

FIGS. 11A and 11B illustrate print setting screens of the printer driver at the time of selecting a paper feed unit.

FIG. 12 is a flowchart illustrating processing of accepting settings of copying on an operation unit of the image formation apparatus.

FIGS. 13A and 13B illustrate print setting screens on the operation unit of the image formation apparatus.

FIG. 14 is an example of printing of a reuse mark.

### DESCRIPTION OF THE EMBODIMENTS

Exemplary embodiments of the present disclosure will be described in detail with reference to the accompanying drawings. The following exemplary embodiments described below are provided as examples, without limiting the disclosure to all combinations of features described in the exemplary embodiments. In the following exemplary embodiments, an image formation apparatus may be described as an example of an information processing apparatus, but the present disclosure is not so limited.

A typical image formation apparatus has a plurality of printing functions, such as a printing function from a printer driver, a copy function, a scanner function, and a fax function. The image formation apparatus according to each exemplary embodiment can execute a normal print process and a decolorable print process. Specifically, the decolorable print process refers to a decolorable toner printing function that performs a print process in which characters and images are printed using a decolorable toner (decolorable recording material) instead of a normal toner (non-decolorable recording material) and the printed characters and images can be decolored afterward.

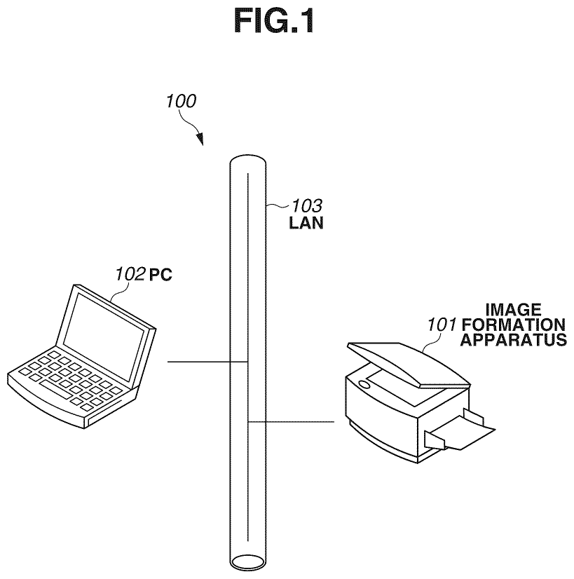

FIG. 1 illustrates components of a printing system. As illustrated in FIG. 1, a printing system 100 is provided that includes an image formation apparatus 101 connected to the Internet via a local area network (LAN) 103, such as Ethernet®. The printing system 100 also includes a personal computer (PC) 102 as a terminal. The PC 102 and the image formation apparatus 101 can communicate with each other via the network.

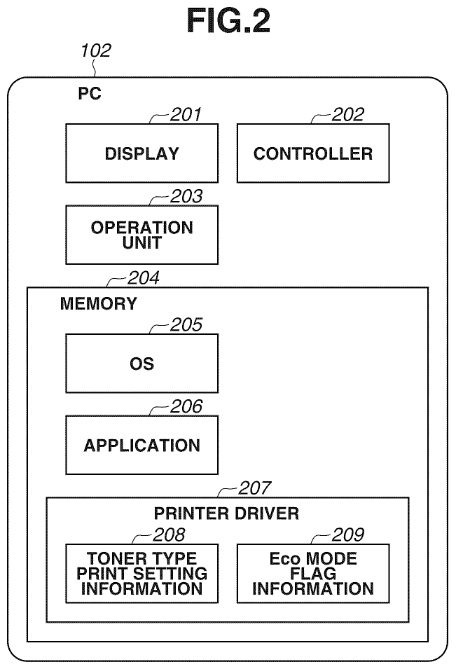

FIG. 2 is a system configuration diagram of the PC 102. The PC 102 is not limited to a personal computer, and may be a tablet, a smartphone terminal, or the like. The PC 102 can transmit a print job to the image formation apparatus 101. The PC 102 includes a display 201, a controller 202, an operation unit 203, and a memory 204.

The display 201 is a screen display device of a PC, a touch panel of a tablet, or the like, and displays a setting screen for a print job. The controller 202 controls the entire PC 102. The controller 202 includes a central processing unit (CPU). The controller 202 reads various programs stored in the memory 204 and executes the read programs, thereby implementing functions of the PC 102. The operation unit 203 accepts various operations from a user using a key, a button, a touch panel, or a keyboard or a mouse of a PC.

The memory 204 includes an operating system (OS) 205, an application 206, and a printer driver 207 specific to the image formation apparatus 101. The printer driver 207 holds toner type print setting information 208 as setting information on a toner type used in printing by the image formation apparatus 101. The setting information on the toner type is information indicating whether to use normal toner or decolorable toner, and the like (and may also include color/monochrome information). The printer driver 207 also holds Eco mode flag information 209 indicating that the decolorable toner is selected as the toner type. The Eco mode flag information 209 may be set by the printer driver 207 as a default value of a toner type print setting. The Eco mode flag information 209 is linked to an off/on state of an Eco mode button of the printer driver 207 described below.

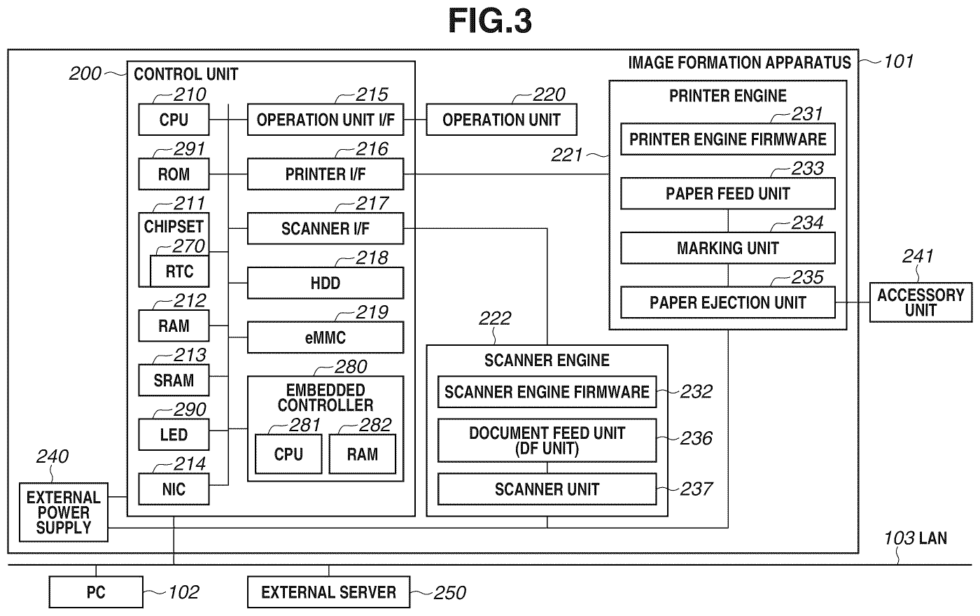

FIG. 3 illustrates an example of a hardware configuration of the image formation apparatus 101. A processor, e.g., a control unit 200 including a CPU 210 controls the operation of the entire image formation apparatus 101. The CPU 210 reads control programs stored in an embedded MultiMediaCard (eMMC) 219, which is a semiconductor storage device, and executes various control processes, such as reading control, printing control, and firmware update control. The eMMC 219 is also used as a work area and a user data area. A read only memory (ROM) 291 stores a startup program, fixed parameters, and the like of the image formation apparatus 101. A random access memory (RAM) 212 is used as a main memory of the CPU 210 and a temporary storage area, such as a work area.

A static RAM (SRAM) 213 is a non-volatile memory that stores setting values and image adjustment values required by the image formation apparatus 101, and is designed so that data is not lost even when the power is turned off and on again.

A hard disk drive (HDD) 218 has a file storage area for firmware update, and also stores image data, user data, and the like. The HDD 218 may not be installed, in which case the file storage area for firmware update, image data, user data, and the like are all stored in the eMMC 219. An operation unit I/F 215 connects an operation unit 220 and the control unit 200. The operation unit 220 is equipped with a liquid crystal display unit having a touch panel function, a keyboard, or the like.

A printer interface (I/F) 216 connects a printer engine 221 and the control unit 200. The printer engine 221 includes a ROM in which printer engine firmware 231 is stored. Image data to be printed by the printer engine 221 is transferred from the control unit 200 to the printer engine 221 via the printer I/F 216 and is printed on a recording medium by the printer engine 221.

The printer engine 221 also includes a paper feed unit 233 with a plurality of paper feed cassettes that store recording paper, and a marking unit 234 that transfers and fixes image data onto the recording paper. In the present exemplary embodiment, the paper feed unit 233 includes a reuse paper feed cassette (reuse cassette) in addition to a paper feed cassette that holds normal new paper. The reuse cassette is a cassette that holds paper that has undergone a decoloring process on contents printed with decolorable toner by an erasing device and has become reusable. The marking unit 234 transfers and fixes image data to recording paper using decolorable toner (decolorable color material) and non-decolorable toner (normal color material). The decoloring process is, for example, a process by which characters and images printed on paper with decolorable toner (decolorable recording material) are decolored by applying a predetermined amount of heat to make the paper reusable.

A paper ejection unit 235 ejects the printed recording paper to the outside. If the paper ejection unit 235 is connected to an accessory unit 241 that is connected to the outside of the image formation apparatus 101, the paper ejection unit 235 ejects the recording paper to the accessory unit 241. The accessory unit 241 performs finishing processing (post-processing), such as sorting and stapling, on the printed matter, and ejects the resulting printed matter.

A scanner I/F 217 connects a scanner engine 222 and the control unit 200. A ROM included in the scanner engine 222 stores scanner engine firmware 232. The scanner engine 222 reads an image on an original document, generates image data, and inputs the image data to the control unit 200 via the scanner I/F 217.

The scanner engine 222 also includes a document feed unit 236 that conveys an original document sheet, and a scanner unit 237 that optically reads an image of the original document and converts the image into image data in the form of an electrical signal.

A network I/F card (NIC) 214 connects the control unit 200 (image formation apparatus 101) to the LAN 103. The NIC 214 transmits image data and information to an external device (for example, an external server 250 or the PC 102) on the LAN 103, and, in reverse, receives update firmware and various types of information from the external device. The external server 250 may exist on the Internet.

The PC 102 may operate the image formation apparatus 101 from a web browser. A chipset 211 refers to a plurality of integrated circuits related to each other. A real time clock (RTC) 270 is used for time measurement. While an external power supply 240 cuts off power supply in response to an instruction from a control program stored in the eMMC 219, even if the external power supply 240 is not connected, the chipset 211 can operate even in a sleep mode because it receives power supply from a built-in battery. In a state where power is partially supplied to the chipset 211, the chipset 211 can recover from the sleep mode. Conversely, in a shutdown state where no power is supplied to the chipset 211, the RTC 270 cannot operate. A light emitting diode (LED) 290 is turned on as necessary and is used to notify software or hardware abnormalities to the outside.

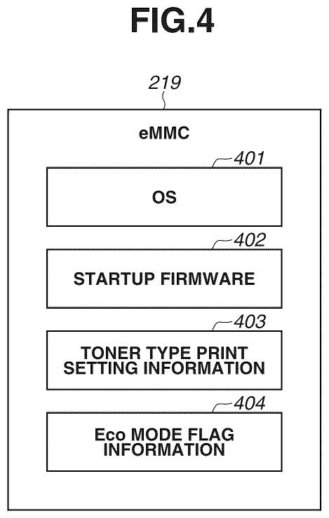

FIG. 4 is a diagram illustrating a configuration of firmware stored in the eMMC 219, which is a semiconductor storage device, of the image formation apparatus 101. The eMMC 219 includes an OS 401 and startup firmware 402 as programs executed by the CPU 210. The startup firmware 402 includes programs for the image formation apparatus 101 to operate and provide functions. In addition, the eMMC 219 also holds toner type print setting information 403. The toner type print setting information 403 is similar to the toner type print setting information 208 held by the printer driver 207. The toner type print setting information 403 is used by the user to make print settings on the operation unit 220 of the image formation apparatus 101. The eMMC 219 also holds Eco mode flag information 404 indicating that the decolorable toner is selected for the toner type. The Eco mode flag information 404 may be set in device settings of the image formation apparatus 101 as a default value of the print setting of the toner type. The Eco mode flag information 404 is linked to the off/on state of an Eco mode button on the print setting screen of the image formation apparatus 101 described below.

Next, the print settings of the printer driver will be described. The user makes the settings according to a purpose of use of an output material in the printer driver. For example, with regard to each output material produced with normal toner or decolorable toner, the user can set whether the output material will be used as an official document or will be reused afterward.

Table 1 illustrates the toner type print setting information 208 of the printer driver 207 and setting items according to the toner type held in the toner type print setting information 208 in the image formation apparatus 101.

TABLE 1
Print Setting Items by Toner Type

| | Normal toner | Decolorable toner |
|---|---|---|
| | printing | printing |
| Paper | No limit | A4, B5, and A5 (paper of |
| | | sizes that are erasable |
| | | by erasing device) |
| Paper feed unit | Enabled except | Priority on reuse cassette |
| | for reuse cassette | |
| Finishing settings such as | No limit | Disabled except for sorting |
| stapling/soring/grouping | | |
| Reuse mark printing | Disabled | Enabled |
| Color mode | Enabled in | Enabled in decolorable |
| | normal toner | toner mode only |
| | mode only | |

In Table 1, the setting item “Paper” does not need to be particularly limited in the normal toner printing.

On the other hand, in the decolorable toner printing, the printed contents are erased by an erasing device to reuse the paper. Thus, only paper of sizes erasable by the erasing device can desirably be selected. As an example, A4, B5, and A5 are described as being erasable, without limiting the present disclosure to this example.

With regard to the setting item “Paper feed unit,” it is desirable that only the paper feed cassette for new paper is used for the normal toner printing, and prioritize the reuse cassette for the decolorable toner printing, which holds paper from which the printed contents have been erased by the erasing device.

The setting item “Finishing settings such as stapling” does not need to be particularly limited for the normal toner printing. However, for the decolorable toner printing, if finishing processing other than sorting, such as stapling, folding, and hole punching, is performed by the accessory unit 241 of the image formation apparatus 101, the paper cannot be reused. Thus, it is desirable to disable settings other than the sorting.

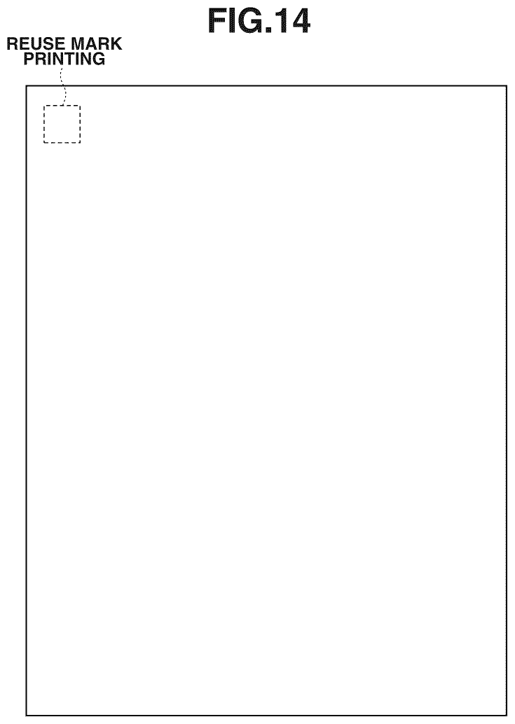

The setting item “Reuse mark printing” allows the user to print a reuse indicator and a mark outside a printing area at the time of printing with decolorable toner, so that the user can check the type of toner of the output material and reuse a reusable output material with certainty (see FIG. 14). It is desirable that the setting be disabled for the normal toner printing and enabled for the decolorable toner printing.

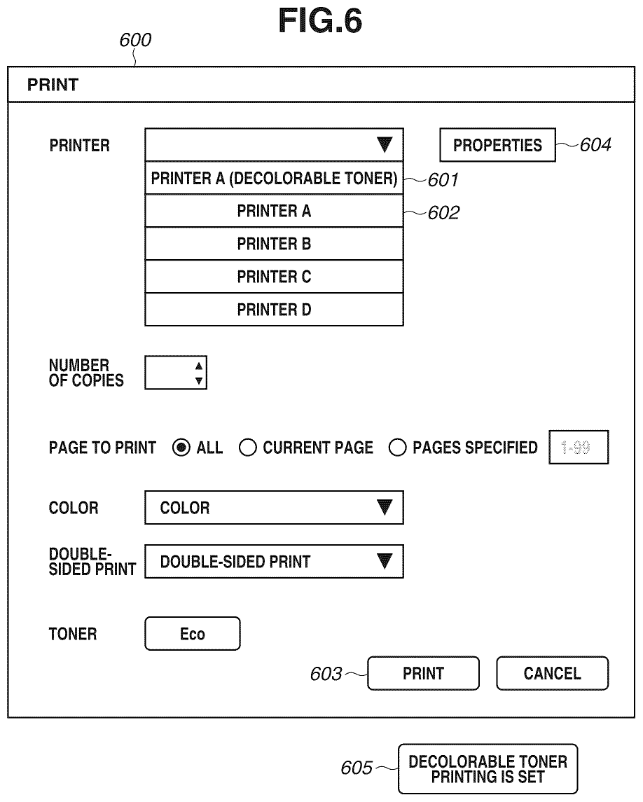

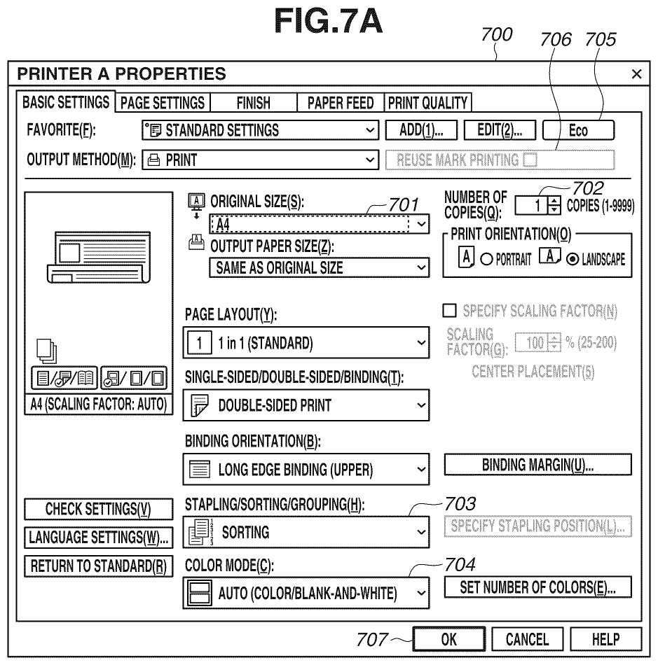

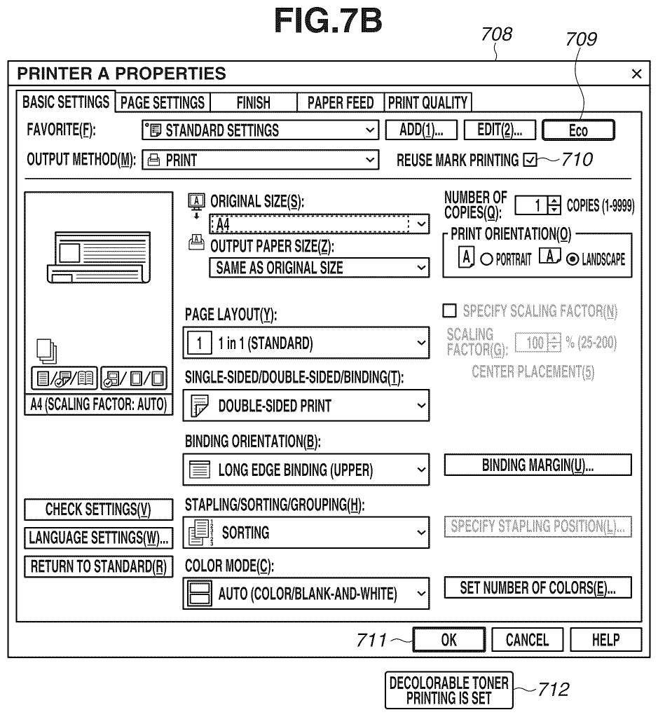

Next, print setting screens illustrated in FIGS. 6, 7A, and 7B will be described. FIG. 6 illustrates a print setting screen 600 of the application 206. On the print setting screen 600 of the application 206, the user selects an image formation apparatus to be used for printing. At that time, in a pull-down list for printer driver selection in the print setting screen 600, printer drivers for a plurality of available image formation apparatuses (printers A to D) are displayed. Herein, the printer A will be described as the image formation apparatus 101. The printer driver for the image formation apparatus 101 displays two selectable icons, an icon 601 for a printer driver for decolorable toner and an icon 602 for a printer driver that does not specify the toner type. This allows the user to select a printer driver suitable for the toner to be used in the image formation apparatus 101.

When the user presses a print button 603, the controller 202 transmits the print job to the selected image formation apparatus. At that time, if the decolorable toner printing is set, the controller 202 can display a dialog 605 to notify the user that the decolorable toner printing is set. When the user selects a properties button 604, the controller 202 of the PC 102 starts the selected printer driver, and the print setting screen (properties screen) of the corresponding image formation apparatus is displayed.

FIGS. 7A and 7B illustrate print setting screens (display screens) of the printer driver 207. The print setting screen of the printer driver 207 is displayed on the display 201.

FIG. 7A illustrates a normal toner print setting screen 700 of the printer driver 207. The normal toner print setting screen 700 includes an original size setting item 701, a number-of-copies setting item 702, a stapling/sorting/grouping finishing setting item 703, and a color mode setting item 704. An Eco mode button 705 switches between the normal toner and the decolorable toner. When the Eco mode button 705 is turned on, the decolorable toner is selected as Eco mode. A reuse mark printing setting item 706 is used to select whether to print a mark on an output material to identify whether the output material is reusable, at the time of printing with the decolorable toner. An OK button 707 is pressed by the user upon completion of the print setting. In the normal toner print setting screen 700, the Eco mode button 705 is displayed in the off state. In the toner type print setting items in Table 1 described above, for the normal toner, the reuse mark printing setting item 706 is not selectable and is thus non-editable, and the background thereof is displayed in the same color as that of the print setting screen of the normal printer driver.

FIG. 7B illustrates a decolorable toner print setting screen 708 for the printer driver 207. The decolorable toner print setting screen 708 includes the same setting items as those of the normal toner print setting screen 700, except that an Eco mode button 709 is displayed in the on state. In the toner type print setting items in Table 1 described above, for the decolorable toner, a reuse mark printing setting item 710 is selectable and is thus editable, and the background thereof is displayed in a color different from that of the print setting screen of the normal printer driver. An OK button 711 is pressed by the user upon completion of the print setting, as with the OK button 707 of the normal toner print setting screen 700. When the OK button 711 is pressed, a dialog 712 is displayed so that the user can be notified that the printing will be performed with the decolorable toner.

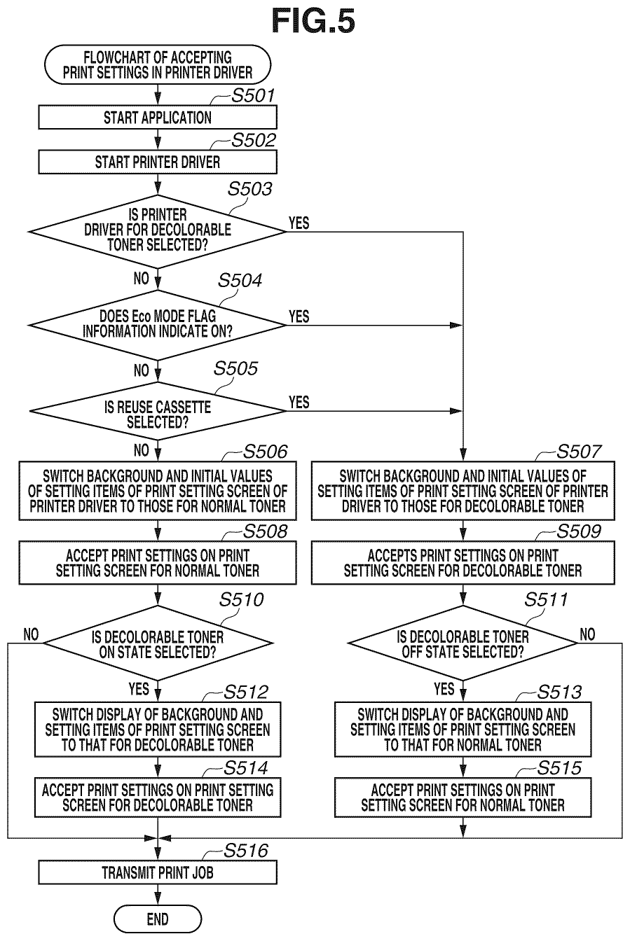

Next, processing of accepting print settings in the printer driver of the PC 102 will be described with reference to the flowchart of FIG. 5.

In step S501, the controller 202 starts the application 206 and displays a document file or the like on the display 201. When the controller 202 of the PC 102 is instructed to print the file on the application 206, the controller 202 displays the print setting screen 600 of the application 206.

If the printer driver for the image formation apparatus 101 (printer A) is selected on the print setting screen 600, in step S502, the controller 202 of the PC 102 starts the printer driver 207 for the image formation apparatus 101. Specifically, when the user selects the printer driver (image formation apparatus 101) to be used and presses the properties button 604, the controller 202 starts the printer driver 207 for the image formation apparatus 101.

At the time of startup, in step S503, the printer driver 207 checks whether a printer driver for decolorable toner is selected on the print setting screen 600 of the application 206. Specifically, the printer driver 207 checks whether the icon 601 for the printer driver for decolorable toner is selected.

If the icon 601 is not selected and the printer driver is selected without specifying the toner type (NO in step S503), in step S504, the printer driver 207 checks whether the Eco mode flag information 404 indicates an on state. Specifically, if the icon 602 is selected, the processing proceeds to S504.

If the Eco mode flag information 404 is not in the on state (NO in step S504), in step S505, the printer driver 207 checks via the LAN 103 whether the reuse cassette is selected in the paper feed unit 233 of the image formation apparatus 101. If the reuse cassette is not selected (NO in step S505), in step S506, the printer driver 207 displays the normal toner print setting screen 700 (FIG. 7A) in which the background color and the setting items of the print setting screen of the printer driver 207 are switched to those for the normal toner. Specifically, the printer driver 207 checks via the LAN 103 whether the reuse cassette is selected in the paper feed unit 233 of the image formation apparatus 101.

If the printer driver for decolorable toner is selected in step S503 (YES in step S503), if the Eco mode flag information 404 indicates the on state in step S504 (YES in step S504), or if the reuse cassette is selected in step S505 (YES in step S505), the processing proceeds to S507.

In step S507, the printer driver 207 displays the decolorable toner print setting screen 708 (FIG. 7B) in which the background color and the setting items of the print setting screen of the printer driver 207 are switched to those for the decolorable toner.

In step S506, the printer driver 207 displays the normal toner print setting screen 700. Then, in step S508, the printer driver 207 accepts print settings on the normal toner print setting screen 700.

When accepting the user's print settings, in step S510, the printer driver 207 checks the on/off state of the Eco mode button to see whether the decolorable toner is selected. When the user turns the Eco mode button 705 from off to on, in step S512, the printer driver 207 switches the background color and the setting items of the print setting screen to those for the decolorable toner and displays them. In step S514, the printer driver 207 continues to accept print settings on the decolorable toner print setting screen 708. In step S510, if the user makes print settings with the Eco mode button 705 in the off state (NO in step S510), the printer driver 207 accepts the print settings while keeping the screen display for the normal toner.

In step S507, the printer driver 207 displays the decolorable toner print setting screen 708, and in step S509, the printer driver 207 accepts print settings on the decolorable toner print setting screen 708. When accepting the user's print settings, in step S511, the printer driver 207 checks the on/off state of the Eco mode button to see whether the decolorable toner is selected, as in step S510. If the user turns the Eco mode button 709 from on to off (YES in step S511), in step S513, the printer driver 207 switches the background color and the setting items of the print setting screen to those for the normal toner and displays them. If setting items used solely for the decolorable toner have been set, the setting items are reset to the initial values of the setting items when the normal toner is selected for the print setting items by toner type in Table 1.

In S515, the printer driver 207 continues to accept print settings on the normal toner print setting screen 700. In step S511, if the printer driver 207 accepts print settings from the user with the Eco mode button 709 in the on state (NO in step S511), the printer driver 207 accepts print settings with the decolorable toner print setting screen 708 displayed.

When the user completes the print settings and presses the print button of the printer driver, in step S516, the controller 202 of the PC 102 generates a print job based on the set print settings and transmits the print job to the image formation apparatus 101. If decolorable toner printing is set, the dialog 605 may be displayed before transmission of the print job to notify the user that the decolorable toner printing will be performed.

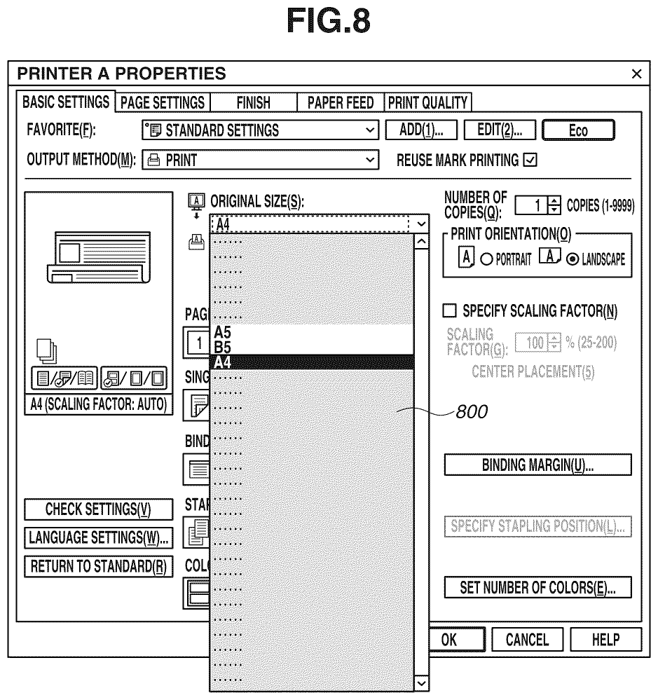

Next, an example of editing each setting item on the print setting screen will be described with reference to FIGS. 8 to 11.

FIG. 8 illustrates an example of editing the original size setting items on the decolorable toner print setting screen 708. In the print setting items by toner type in Table 1 described above, the original sizes for decolorable toner printing are only A4, B5, and A5. Therefore, a pull-down list 800 for the original size setting items on the decolorable toner print setting screen 708 is displayed in such a manner that original sizes other than A4, B5, and A5 are grayed out and cannot be selected. The unselectable original sizes may be hidden from view. In the case of the normal toner printing, there are no restrictions, and all original sizes can be selected.

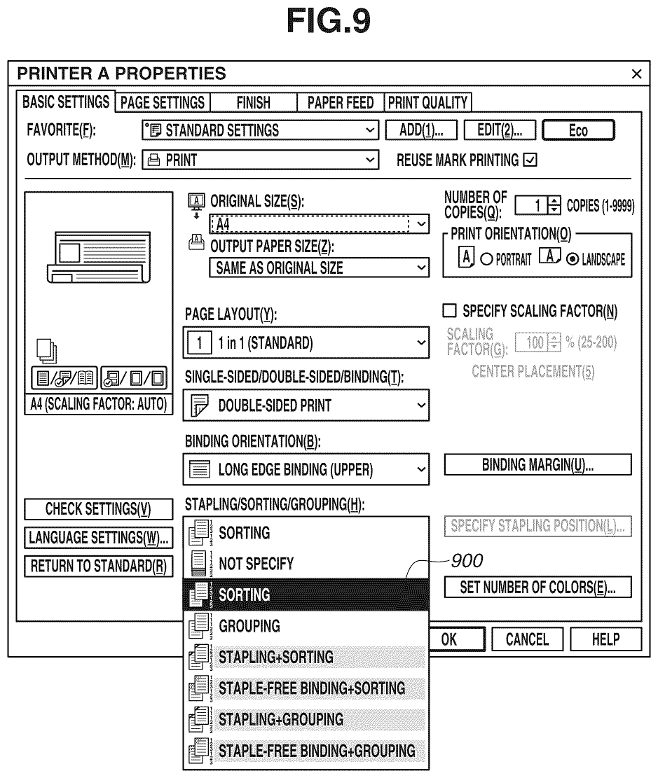

FIG. 9 illustrates an example of editing finishing setting items of stapling/sorting/grouping on the decolorable toner print setting screen 708. In the print setting items by toner type in Table 1 described above, the finishing setting items of stapling/sorting/grouping for the decolorable toner printing are disabled except for the sorting. Therefore, a pull-down list 900 for the finishing setting items of stapling/sorting/grouping on the decolorable toner print setting screen 708 is displayed in such a manner that finishing settings other than the sorting are grayed out and cannot be selected. The unselectable finishing settings may be hidden from view without being grayed out. In the case of the normal toner printing, there are no restrictions, and all finishing settings can be selected.

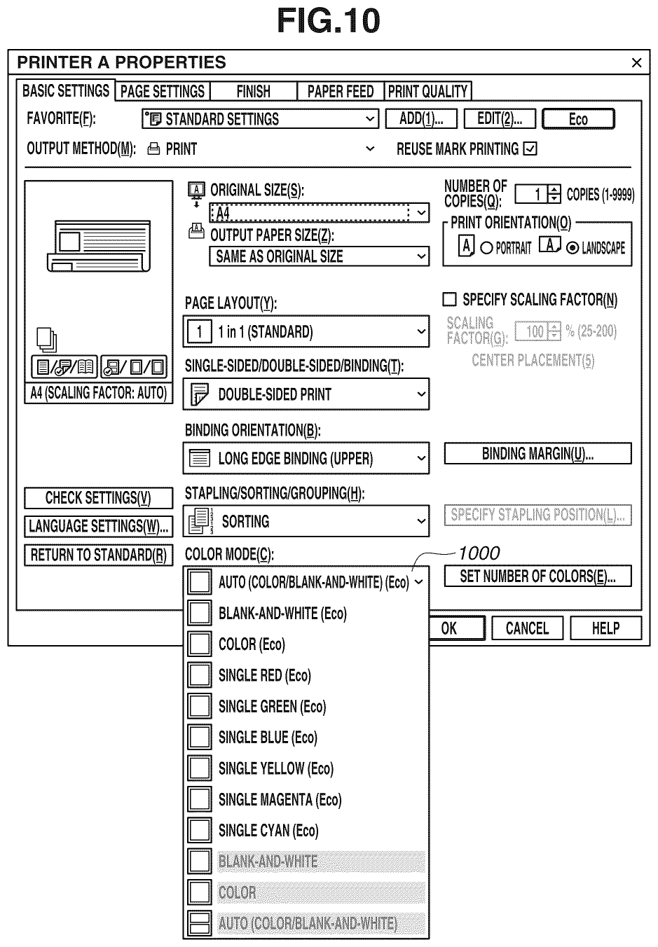

FIG. 10 illustrates an example of editing the color mode setting items on the decolorable toner print setting screen 708. When the decolorable toner is selected in the print setting items by toner type in Table 1 described above, the user is not allowed to select any items in the color mode other than those corresponding to the decolorable toner.

Therefore, in a pull-down list 1000 for the color mode setting items on the decolorable toner print setting screen 708, color mode settings other than those for the decolorable toner are grayed out. The unselectable color mode settings may be hidden from view without being grayed out. In the case of the normal toner printing, the mode settings corresponding to the decolorable toner are made unselectable.

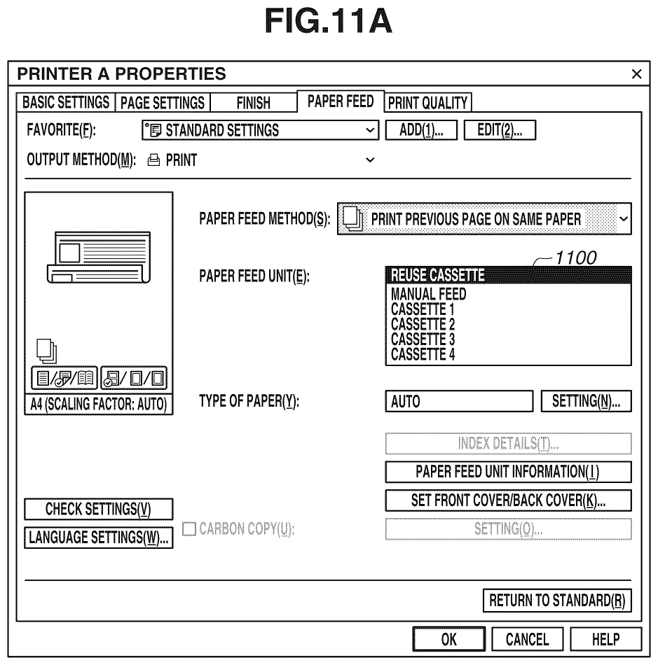

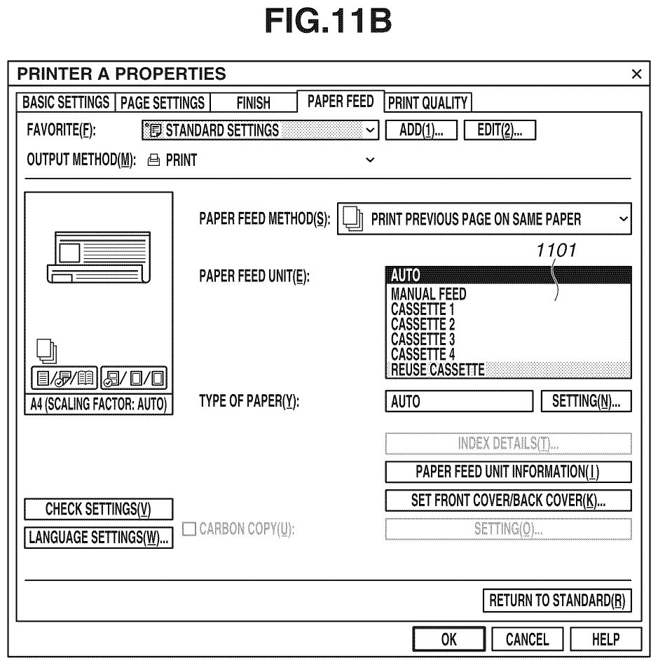

FIG. 11A illustrates an example in which the paper feed tab is selected on the decolorable toner print setting screen 708. The PC 102 acquires paper feed cassette information from the image formation apparatus 101. When the decolorable toner is selected in the print setting items by toner type in Table 1 described above, the reuse cassette is given priority. Therefore, in a pull-down list 1100 for paper feed tab setting items on the decolorable toner print setting screen 708, the reuse cassette is displayed in a selectable manner or may be set as a default selection. If the user wishes to print on paper from another cassette even though the toner is the decolorable toner, the user can select the other cassette.

FIG. 11B illustrates an example in which the paper feed tab is selected on the normal toner print setting screen 700. When the normal toner is selected in the print setting items by toner type in Table 1 described above, the use of the reuse cassette is disabled. This is because there is a possibility that color of the decolorable toner may be recovered under certain conditions (such as low temperature). Therefore, in a pull-down list 1101 for paper feed tab setting items on the normal toner print setting screen 700, the reuse cassette is grayed out and cannot be selected. Alternatively, the reuse cassette, which cannot be set, may be hidden from view without being grayed out.

In this manner, the controller 202 of the PC 102 accepts the print settings on the print setting screen of the printer driver 207. When the print settings are accepted, the printer driver screen is closed. After the print settings are accepted on the decolorable toner print setting screen 708 and before the printer driver screen is closed, the dialog 712 may be displayed to notify the user that decolorable toner printing will be performed.

As described above, the print setting screen of the printer driver is displayed as a user interface that can be visually recognized according to the selected toner type, which makes it possible to improve operability for the user. Specifically, by setting the print settings while being aware of the toner type, the user can execute printing without making a mistake in the toner type for the output. In addition, displaying the print setting items by changing available settings according to the selected toner type allows the user to make appropriate print settings while being aware of the toner type, which results in improvement of convenience.

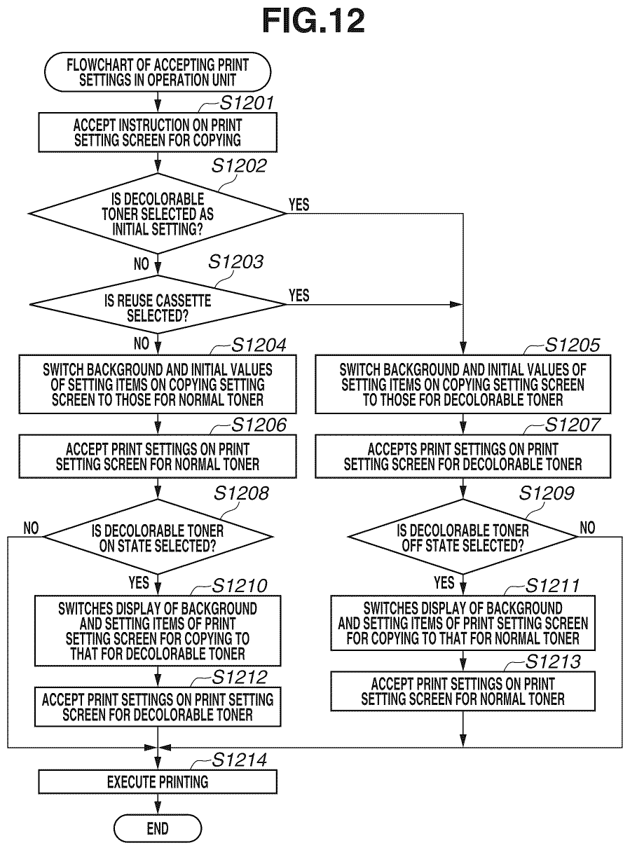

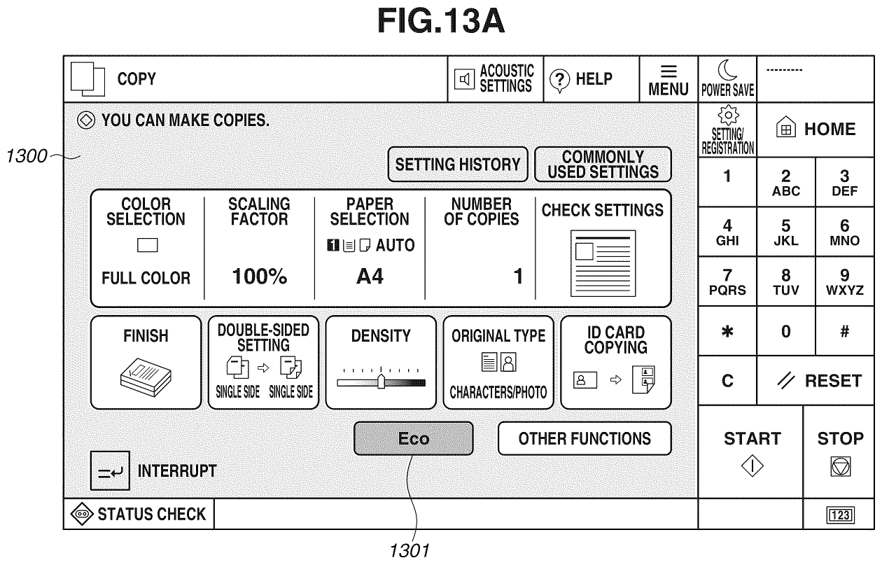

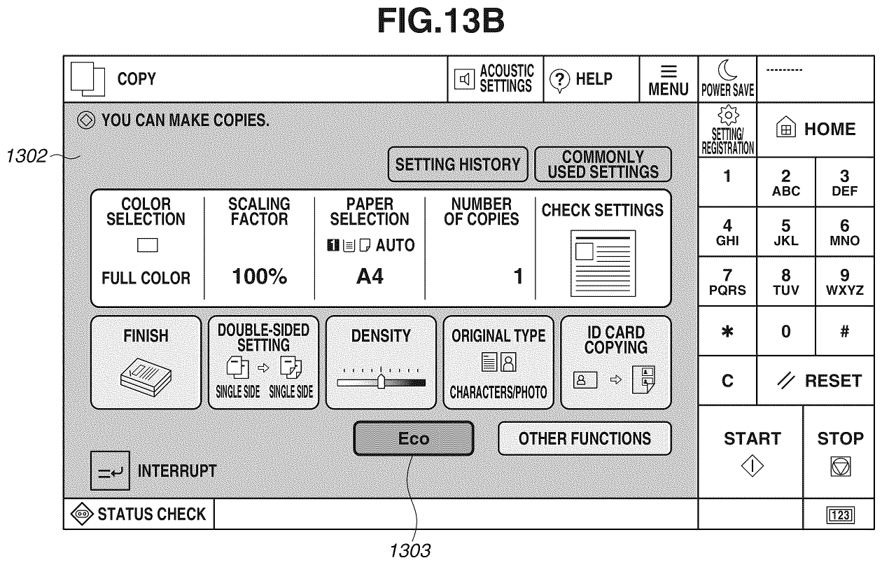

As a second exemplary embodiment, a print setting screen of an operation unit 220 of an image formation apparatus 101 will be described with reference to FIGS. 12, 13A, and 13B. In print settings of the image formation apparatus 101, as in the print settings on the printer driver of the PC, it is possible to accept the print settings while making the user visually aware of the toner type.

FIG. 12 is a flowchart illustrating processing of accepting the print settings on the operation unit 220 at the time of copying on the image formation apparatus 101. The processing in the flowchart illustrated in FIG. 12 is executed by the CPU 210 in accordance with the program stored in the eMMC 219 illustrated in FIG. 3.

In step S1201, the image formation apparatus 101 accepts an instruction from the user on a print setting screen for copying of the operation unit 220. Then, in step S1202, the image formation apparatus 101 checks whether the decolorable toner is selected in initial settings. The initial settings may be default device settings that are preset in the Eco mode flag information 404 stored in the eMMC 219 of the image formation apparatus 101.

Toner type print setting information 403 may hold desirable settings according to the toner type in Table 1, as does the toner type print setting information 208 held in the printer driver 207. If the Eco mode flag information 404 is set to on by default (YES in step S1202), in step S1205, the image formation apparatus 101 switches the background color and the initial values of the setting items on the print setting screen for copying to those for the decolorable toner, and displays them on the operation unit 220.

If the decolorable toner is not selected in the initial settings (NO in step S1202), in step S1203, the image formation apparatus 101 checks whether the reuse cassette is selected. If the reuse cassette is selected (YES in step S1203), in step S1205, the image formation apparatus 101 switches the background color and the initial values of the setting items on the print setting screen for copying to those for the decolorable toner, and displays them on the operation unit 220. If the reuse cassette is not selected (NO in step S1203), in step S1204, the image formation apparatus 101 switches the background color and the initial values of the setting items on the print setting screen for copying to those for the normal toner, and displays them on the operation unit 220.

FIG. 13A illustrates a normal toner print setting screen 1300 at the time of copying in a case where the normal toner is set on the image formation apparatus 101. An Eco mode button 1301 switches between the normal toner and the decolorable toner, as does the Eco mode button on the print setting screen of the printer driver 207. When the Eco mode button 1301 is turned on, the decolorable toner is selected as Eco mode. On the normal toner print setting screen 1300, the Eco mode button 1301 is displayed in the off state.

FIG. 13B illustrates a decolorable toner print setting screen 1302 at the time of copying in a case where the decolorable toner is set on the image formation apparatus 101. An Eco mode button 1303 switches between the normal toner and the decolorable toner. On the decolorable toner print setting screen 1302, the Eco mode button 1303 is displayed in the on state, and the background of the screen is displayed in a color different from that of the normal toner print setting screen 1300 so that the user can easily recognize that the decolorable toner is selected.

In step S1204, the image formation apparatus 101 displays the normal toner print setting screen 1300 on the operation unit 220, and in step S1206, the image formation apparatus 101 accepts print settings on the normal toner print setting screen 1300. When accepting the user's print settings from the operation unit 220, in step S1208, the image formation apparatus 101 checks the on/off state of the Eco mode button 1301 to see whether the decolorable toner is selected, as does the printer driver 207.

If the user has turned the Eco mode button 1301 from off to on (YES in step S1208), in step S1210, the image formation apparatus 101 switches the background color and the setting items on the print setting screen for copying to those for the decolorable toner, and displays them. If the setting items used solely for the normal toner have been set, the image formation apparatus 101 resets the setting items to the initial values of the setting items when the decolorable toner is selected for the print setting items by toner type in Table 1. Then, in step S1212, the image formation apparatus 101 continues to accept print settings on the decolorable toner print setting screen 1302. If the Eco mode button 1301 remains in the off state (NO in step S1208), the image formation apparatus 101 accepts print settings while keeping the display for the normal toner.

On the other hand, in step S1205, the CPU 210 of the image formation apparatus 101 displays the decolorable toner print setting screen 1302 on the operation unit 220, and in step S1207, the CPU 210 accepts print settings on the decolorable toner print setting screen 1302. When accepting the user's print settings from the operation unit 220, in step S1209, the CPU 210 checks the on/off state of the Eco mode button 1303 to see whether the decolorable toner is selected, as in the case of the printer driver 207.

If the user turns the Eco mode button 1303 from on to off (YES in step S1209), in step S1211, the image formation apparatus 101 switches the background color and the setting items on the print setting screen for copying to those for the normal toner, and displays them. If the setting items used solely for the decolorable toner have been set, the image formation apparatus 101 resets the setting items to the initial values of the setting items when the normal toner is selected for the print setting items by toner type in Table 1. Then, in step S1213, the image formation apparatus 101 continues to accept print settings on the normal toner print setting screen 1300. If the Eco mode button 1303 remains in the on state (NO in step S1209), the image formation apparatus 101 accepts print settings while keeping the display for the decolorable toner.

When the user completes the print settings and issues a print instruction from the operation unit 220, in step S1214, the image formation apparatus 101 executes print processing based on the print settings that have been set.

In the second exemplary embodiment, the copy processing is taken as an example, without limiting processing to which the present disclosure is to be applied. For example, the processing may be processing to hold a print job and execute the print job according to an execution instruction from the user. Specifically, the processing may be a box function of holding print jobs in a folder for each user, reservation processing of reserving a print job received from a PC until the user issues an execution instruction, and reprint processing of re-executing an already-executed print job in response to an execution instruction from the user. In each function, the configuration of the print setting screen described in the second exemplary embodiment may be applied at execution of a print job.

As described above, the print setting screen of the image formation apparatus 101 is displayed as a user interface that can be visually recognized according to the selected toner type, thereby the operability for the user can be improved. Specifically, by setting the print settings while being aware of the toner type, the user can execute printing without making a mistake in the toner type for the output. In addition, displaying the print setting items by changing available settings according to the selected toner type allows the user to make appropriate print settings while being aware of the toner type, which results in improvement of convenience.

Although various examples and exemplary embodiments of the present disclosure have been illustrated and described, the spirit and scope of the present disclosure is not limited to the specific descriptions herein.

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., one or more of a CPU and a micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a ROM, a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-142746, filed Sep. 4, 2023, which is hereby incorporated by reference herein in its entirety.

What is claimed is:

1. A method for controlling an information processing apparatus capable of communicating with an image formation apparatus including a processor capable of controlling print processing using at least one of a non-decolorable recording material and a decolorable recording material, the method comprising:
displaying a printer driver configured to transmit a print job to the image formation apparatus; and
controlling switching of the printer driver between a first display in a case where the non-decolorable recording material is used and a second display in a case where the decolorable recording material is used.

2. The method according to claim 1, further comprising:
accepting a setting to use the decolorable recording material while the first display is displayed on the printer driver; and
switching the printer driver from the first display to the second display based on the accepted setting.

3. The method according to claim 1, further comprising:
accepting a setting to use the non-decolorable recording material while the second display is displayed on the printer driver; and
switching the printer driver from the second display to the first display based on the accepted setting.

4. The method according to claim 1,
wherein, when a mode for executing the decolorable print processing is selected on a first screen of the printer driver and an instruction to switch from the first screen to a second screen is accepted, the second display is displayed instead of the first display on the second screen,
wherein, a reuse mark printing setting item is displayed for printing, at the time of printing with the decolorable toner, a mark on an output material, and
wherein the mark identifies that the output material is reusable.

5. The method according to claim 1, further comprising:
acquiring, from the image formation apparatus, information on a reuse paper feed cassette in which paper is placed, the paper having undergone the decolorable print processing and then having undergone decoloring processing of erasing a printed content; and
accepting a setting to use the reuse paper feed cassette while the first display is displayed on the printer driver,
wherein, when the information on the reuse paper feed cassette is acquired, the printer driver switches from the first display to the second display based on the accepted setting.

6. The method according to claim 1, further comprising:
acquiring, from the image formation apparatus, information on a paper feed cassette in which paper is placed, the paper having neither undergone the print processing nor undergone the decolorable print processing; and
acquiring, from the image formation apparatus, information on a reuse paper feed cassette in which paper is placed, the paper having undergone the decolorable print processing and then having undergone decoloring processing of erasing a printed content,
wherein, in the first display, at least the paper feed cassette is selectable, and in the second display, at least the reuse paper feed cassette is selectable.

7. The method according to claim 1, wherein the first display and the second display have different background colors.

8. The method according to claim 1,
wherein the first display includes a post-processing setting of binding printed materials by stapling, and
wherein the second display does not include the post-processing setting of binding printed materials.

9. The method according to claim 1, wherein the first display and the second display are configured to display a properties screen of the printer driver.

10. A method for controlling an image formation apparatus including a processor capable of controlling print processing using at least one of a non-decolorable recording material and a decolorable recording material, the method comprising:
printing an image on paper; and
receiving an instruction from a user to execute the print processing, the instruction being input on a display screen that is configured to display at least one print processing setting to the user,
wherein the display screen is switchable between a first display in a case where the non-decolorable recording material is used and a second display in a case where the decolorable recording material is used.

11. The method according to claim 10, further comprising:
accepting a setting to use the decolorable recording material while the first display is displayed on the display screen; and
switching the display screen from the first display to the second display based on the accepted setting.

12. The method according to claim 10, further comprising:
accepting a setting to use the non-decolorable recording material while the second display is displayed on the display screen; and
switching the display screen from the second display to the first display based on the accepted setting.

13. The method according to claim 10,
wherein, when a mode for executing the print processing using the decolorable recording material is selected on a first screen of the display screen and an instruction to switch from the first screen to a second screen is accepted, the second display is displayed instead of the first display on the second screen,
wherein, a reuse mark printing setting item is displayed for printing, at the time of printing with the decolorable toner, a mark on an output material, and
wherein the mark identifies that the output material is reusable.

14. The method according to claim 10,
wherein the image formation apparatus includes a reuse paper feed cassette in which paper is placed, the paper having undergone the print processing using the decolorable recording material and then having undergone decoloring processing of erasing a printed content, and
wherein the display screen switches from the first display to the second display by accepting a setting to use the reuse paper feed cassette.

15. The method according to claim 10,
wherein the image formation apparatus includes a paper feed cassette in which paper is placed, wherein the paper has neither undergone the print processing using the decolorable recording material nor the print processing using the non-decolorable recording material,
wherein the image formation apparatus includes a reuse paper feed cassette in which paper has undergone the print processing using the decolorable recording material and then has undergone decolorable processing of erasing a printed content,
wherein in the first display, at least the paper feed cassette is selectable, and
wherein, in the second display, at least the reuse paper feed cassette is selectable.

16. The method according to claim 10, wherein the first display and the second display have different background colors.

17. The method according to claim 10, further comprising:
performing post-processing of binding printed materials by stapling,
wherein, the first display includes a post-processing setting of binding printed materials by stapling, and
wherein, the second display does not include the post-processing setting of binding printed materials by stapling.

18. The method according to claim 10, wherein the first display and the second display are configured to display a properties screen on which settings of the print processing are made.

19. The method according to claim 1, wherein the print processing includes copy processing.

20. The method according to claim 1,
wherein the print processing includes a print job accepted from an information processing apparatus via a network, and
wherein the print processing is reserved until the user issues an execution instruction.
